(19) United States
(12) Patent Application Publication
(10) Pub. No.: US 2010/0198956 A1
(43) Pub. Date: Aug. 5, 2010

(54) TELEPHONE EXCHANGE APPARATUS AND HOST NAME INFORMATION ASSIGNING METHOD USED THEREFORE

(76) Inventors: Hitoshi Kato, Sagamihara-shi (JP); Fumio Shibasaki, Sagamihara-shi (JP); Shuichi Sato, Sagamihara-shi (JP)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/695,779

(22) Filed: Jan. 28, 2010

(30) Foreign Application Priority Data
Jan. 30, 2009 (JP) 2009-019684

(51) Int. Cl. G06F 15/173; H04L 12/66; G06F 15/16

(52) U.S. Cl. 709/223; 370/352; 709/230

(57) ABSTRACT

According to one embodiment, a telephone exchange apparatus includes a generator configured to automatically generate the host name information in accordance with a predetermined condition, when a registration request about an arbitrary communication apparatus to the management table is issued, and a controller configured to register the host name information generated by the generator in the management table by associating the host name information with the corresponding-communication apparatus.

### CROSS-REFERENCE TO RELATED APPLICATIONS

This application is based upon and claims the benefit of priority from Japanese Patent Application No. 2009-019684, filed Jan. 30, 2009, the entire contents of which are incorporated herein by reference.

### BACKGROUND

1. Field

One embodiment of the present invention relates to a telephone exchange apparatus used, for example, for an Internet Protocol (IP) telephone system, and relates to a host name information assigning method for assigning host names to gateways, each telephone terminal, etc., in the telephone exchange apparatus.

2. Description of the Related Art

In recent years, the IP telephone system, which interactively transmits and receives images and voices as packet data in real time via the IP network such as a local area network (LAN) and the Internet, has become widely used. In the IP telephone system, an IP telephone exchange apparatus system, which arranges a plurality of IP telephone exchange apparatuses in the IP network and operates these IP telephone exchange apparatuses as one system, is constructed. In this kind of system, multimedia information communication, to and from IP telephone terminals, and between the IP telephone terminals and the public network through different IP telephone exchange apparatuses as well as multimedia information communication, to and from different IP telephone terminals, and between the IP telephone terminals and the public network for each IP telephone exchange apparatus can be performed.

Meanwhile, in this kind of system, it is necessary for a maintenance person to give a host name which is unique in the system to each IP telephone exchange apparatus, to operate each IP telephone exchange apparatus in the IP telephone system. The maintenance person gives the host name by manually registering the name in each IP telephone exchange apparatuses, or by manually registering the names in a dynamic host configuration protocol (DHCP) server or a domain name system (DNS) server.

Thereby, since the registration of the host names needs much labor and long time, and most parts of registration work are performed manually, human errors occur frequently. This situation becomes remarkable as the number of modules consisting of the system increases, and becomes very undesirable.

For a related technique, in a system consisting of a server and a plurality of clients, a method, in which the server reports terminal identification numbers included in names of terminal hosts corresponding to IP addresses of the clients when the clients are connected to the server, is proposed (e.g., Jpn. Pat. Appln. KOKAI Publication No. 11-127175).

Meanwhile, in the method, the terminal host names which have been registered, are given to the clients, when the clients which are registered in the server in advance are connected, and the maintenance person has to manually register in the server, when the clients which the host names have not been registered yet therein, are connected.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is an exemplary schematic configuration view depicting a first embodiment of an IP telephone exchange apparatus system of the invention;

FIG. 2 is an exemplary block diagram depicting a functional configuration of an IP telephone exchange apparatus regarding the first embodiment of the invention;

FIG. 3 is an exemplary view depicting an example of a storage content of a host name management table shown in FIG. 2;

FIG. 4 is an exemplary view depicting an example of a storage content of a host name registration table shown in FIG. 2;

FIG. 5 is an exemplary sequence view depicting for explaining operations of a system construction in the first embodiment of the invention;

FIG. 6 is an exemplary sequence view depicting communication operations of information among DHCP/DNS server, a maintenance IP telephone exchange apparatus, and IP telephone exchange apparatuses of which the hot names have not registered yet in system registration in the first embodiment of the invention;

FIG. 7 is an exemplary flowchart depicting a control processing procedure of a controller of an IP telephone exchange apparatus in system registration;

FIG. 8 is an exemplary block diagram depicting a functional configuration of an IP telephone exchange apparatus as a second embodiment of the invention; and

FIG. 9 is an exemplary view depicting an example of storage content of a host name management table in the second embodiment of the invention

### DETAILED DESCRIPTION

Various embodiments according to the invention will be described hereinafter with reference to the accompanying drawings. In general, according to one embodiment of the invention, a telephone exchange apparatus which connects a plurality of communication apparatuses via an Internet Protocol network, includes a management table with host name information corresponding to each of the plurality of communication apparatuses registered, and makes the plurality of communication apparatuses execute predetermined communication processing based on the management table, comprising: a generator configured to automatically generate the host name information in accordance with a predetermined condition, when a registration request about an arbitrary communication apparatus to the management table is issued; and a controller configured to register the host name information generated by the generator in the management table by associating the host name information with the corresponding-communication apparatus.

### First Embodiment

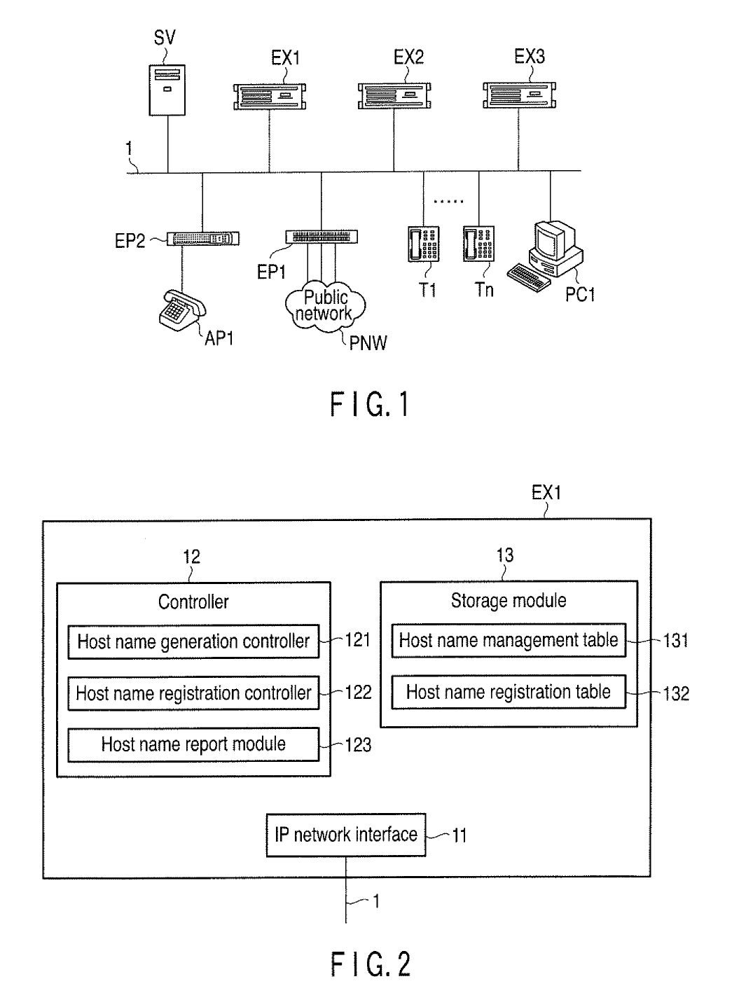

FIG. 1 shows a schematic configuration view illustrating a first embodiment of an IP telephone exchange apparatus system of the invention.

The system includes an IP network 1. IP telephone terminals T1-Tn as communication apparatuses and a maintenance terminal PC1 are connected to the IP network 1. End points EP1, EP2 as communication apparatuses are connected to the IP network 1. The end point EP1 connects the IP network 1 to a public network PNW, and includes an exchange function of a communication protocol and a signal format between the IP network 1 and the public network PNW. The end point EP2 connects the IP network 1 to a standard telephone set AP1, and has an exchange function of a communication protocol and a signal format between the IP network 1 and the standard telephone set AP1.

IP telephone exchange apparatuses EX1, EX2, EX3 are connected to the IP network 1. These IP telephone exchange apparatuses EX1, EX2, EX3 include exchange control functions for the IP telephone terminals T1-Tn, the maintenance terminal PC1 and the end points EP1, EP2.

Further, a DHCP/DNS server SV is connected to the IP network 1. The DHCP/DNS server SV includes an IP address assignment function to the IP telephone exchange apparatuses EX1, EX2, EX3, the IP telephone terminals T1-Tn, the maintenance terminal PC1, and end points EP1, EP2, and includes an address management function of addresses which have been assigned to the IP telephone exchange apparatuses EX1, EX2, EX3, the IP telephone terminals T1-Tn, the maintenance terminal PC1 and the end points EP1, EP2.

The address management function each manages, identification information which has been assigned, for example, to the IP telephone exchange apparatuses EX1, Ex2, Ex3, the IP telephone terminals T1-Tn, the maintenance terminal PC1 and the end points EP1, EP2, a media access control (MAC) address as a fixed network address, and IP addresses as variable network addresses to be assigned to the IP telephone exchange apparatuses EX1, Ex2, Ex3, the IP telephone terminals T1-Tn, the maintenance terminal PC1 and the end points EP1, EP2 at the start-up thereof. The assignment of the IP addresses to the IP telephone exchange apparatuses EX1, Ex2, Ex3, the IP telephone terminals T1-Tn, the maintenance terminal PC1 and the end points EP1, EP2 are performed by using the DHCP which are widely used nowadays.

Meanwhile, the IP telephone exchange apparatus EX1 among the foregoing IP telephone exchange apparatuses EX1, EX2, EX3 functions as a maintenance IP telephone exchange apparatus. The IP telephone exchange apparatus EX1 includes the following functions as the functions of the invention. FIG. 2 shows a block diagram illustrating the configurations of the functions.

That is, the EP telephone exchange apparatus EX1 includes an IP interface module 11, a controller 12, and a storage module 13. Among of them, the IP network interface module 11 performs interface processing to and from the IP network 1.

The storage module 13 stores routing information, etc., necessary for connection control of the controller 12, and includes a host name management table 131 (refereed to as a management table 131), and a host name registration table 132 (referred to as a registration table 132).

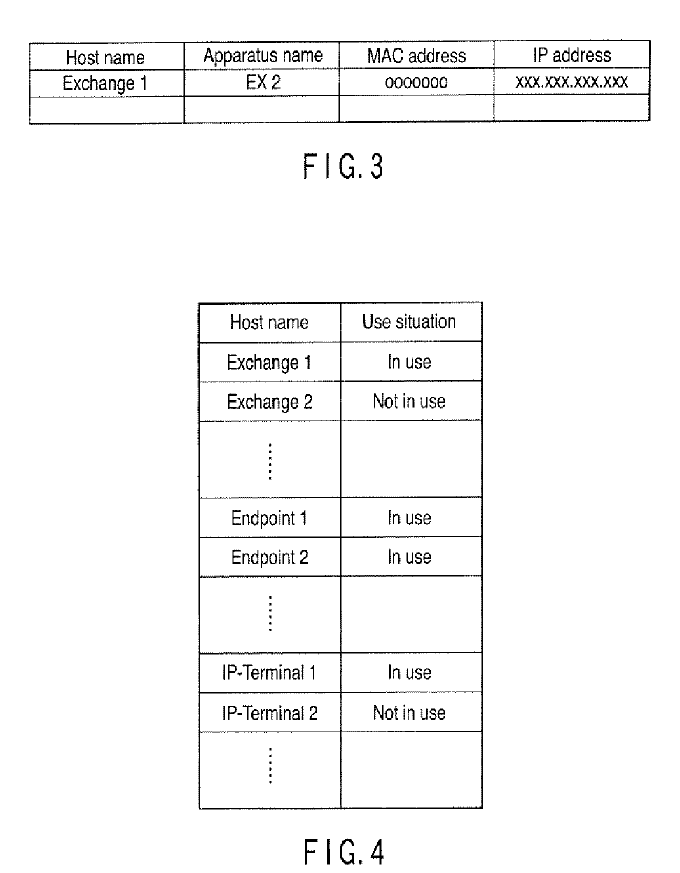

As shown in FIG. 3, the management table 131 stores data expressing a correspondence relationship among apparatus names, the MAC address, the IP address, and the host names to be given to the IP telephone exchange apparatuses EX2, EX3, IP telephone terminals T1-Tn, the maintenance terminal PC1 and the end points EP1, EP2. The apparatus names shows the IP telephone exchange apparatuses EX2, EX3, IP telephone terminals T1-Tn, the maintenance terminal PC1 and the end points EP1, EP2.

As shown in FIG. 4, the registration table 132 stores data expressing a correspondence relationship among pre-created host names showing “Exchange 1”, “Exchange 2” and use situation of the host names.

On the other hand, the controller 12 includes a host name generation controller 121 (referred to as a generation controller 121), a host name registration controller 122 (referred to as a registration controller 122), and a host name report module 123 (referred to as a report module 123) as new functions of the invention.

For instance, the generation controller 121 refers to the registration table 132 based on the MAC address included in a registration request when the registration request regarding the IP telephone exchange apparatus EX2 to the management table 131 is issued. The registration request does not include a host name. If the identical MAC address does not exist in the management table 131, the generation controller 121 refers to the registration table 132 to use an unused host name “Exchange 1”. After this, the generation controller 121 updates the use situation corresponding to the host name “exchange 1” in the registration table 132 from “not in use” to “in use”.

The registration controller 122 associates the host name information “Exchange 1” generated by the generation controller 121 with the apparatus name of the IP telephone exchange apparatus EX2, the Mac address and the IP address and registers the host name information “Exchange 1” in the management table 131.

The report module 123 reports the host name information generated by the generation controller 121 to the IP telephone exchange apparatus EX2.

Next, operations of the IP telephone exchange apparatus system configured as described above will be explained.

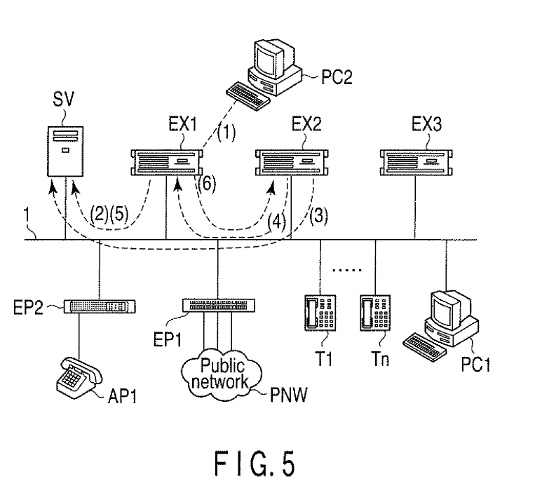

FIG. 5 shows a sequence view illustrating for explaining operations of a system construction in the first embodiment.

For instance, it is assumed that an operator of a maintenance terminal PC2 operates the maintenance terminal PC2 to set a host name and to perform setting as a maintenance IP exchange apparatus of the system to the IP telephone exchange apparatus EX1 ((1) of FIG. 5). The IP telephone exchange apparatus EX1 then accesses the DHCP/DNS server SV to acquire the IP address and to register the information of the IP telephone exchange apparatus EX1 ((2) of FIG. 5).

Subsequently, the IP telephone exchange apparatus EX2 accesses the DHCP/DNS server SV to acquire the IP address and the information of the IP telephone exchange apparatus EX1 that is the maintenance IP telephone exchange apparatus ((3) of FIG. 5). The IP telephone exchange apparatus EX2 then issues a registration request to the IP telephone exchange apparatus EX1 ((4) of FIG. 5).

After this, the IP telephone exchange apparatus EX1 accesses the DHCP/DNS server SV, and reports the host name of the IP telephone exchange apparatus EX2 ((5) of FIG. 5) and performs to give the host name and report the registration to the IP telephone exchange apparatus EX2 ((6) of FIG. 5).

Also for the IP telephone exchange apparatus EX3, the IP telephone terminals T1-Tn, the maintenance terminal PC1 and the end points EP1, EP2, the registration thereof in the system is performed in the same way as that for the IP telephone exchange apparatus EX2, after the completion of the registration of each apparatus in the system, the maintenance terminal PC1 is connected to the IP telephone exchange apparatus EX1 via the IP network 1, and the system is constructed by means of the information of each apparatus collected to the IP telephone exchange apparatus EX1. For instance, the end point EP1 is installed in the IP telephone exchange apparatus EX2, and the end point EP2 is installed in the IP telephone exchange apparatus EX3.

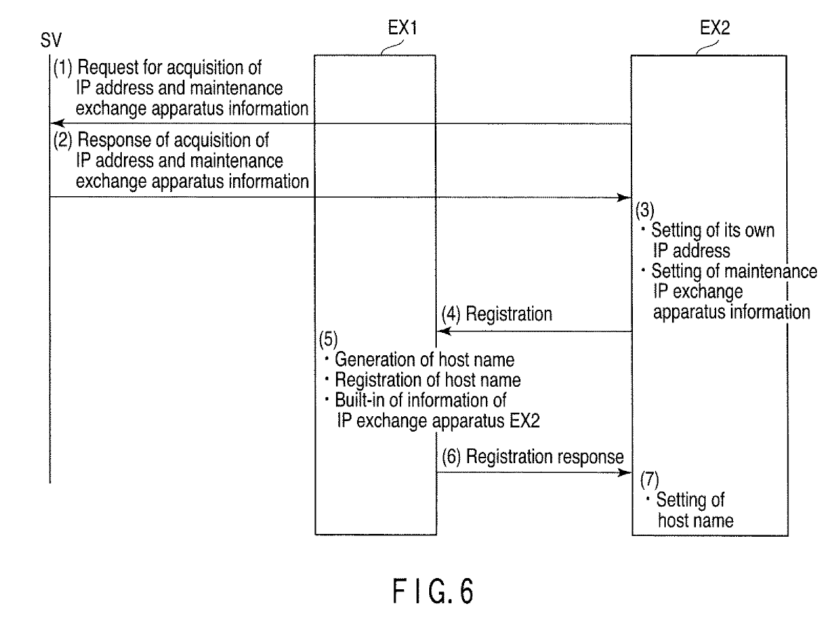

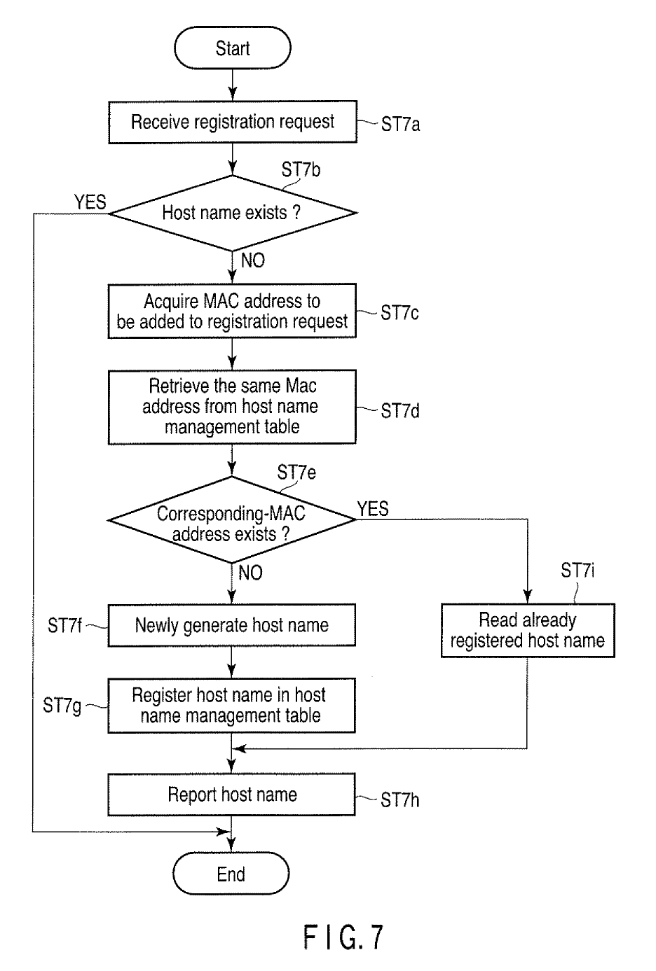

Next, FIG. 6 shows a sequence view illustrating communication operations among the DHCP/DNS server SV, the IP telephone exchange apparatus EX1, and the IP telephone exchange apparatus EX2 at system registration in the IP telephone exchange apparatus EX2. FIG. 7 shows a flowchart illustrating a control processing procedure of the controller 12 of the IP telephone exchange apparatus EX1 at system registration in the IP telephone exchange apparatus EX2.

The IP telephone exchange apparatus EX2 firstly transmits an acquisition request for its own IP address and an acquisition request for the maintenance IP telephone exchange apparatus information to the DHCP/DNS server SV ((1) of FIG. 6). When receiving these acquisition requests, the DHCP/DNS server SV transmits the IP address and the information of the IP telephone exchange apparatus EX1 to the IP telephone exchange apparatus EX2 in response to these acquisition requests ((2) of FIG. 6).

The IP telephone exchange apparatus EX2 receives the IP address and the information of the IP telephone exchange apparatus EX1 from the DHCP/DNS server SV to set its own IP address and the maintenance IP telephone exchange apparatus information ((3) of FIG. 6).

Subsequently, the IP telephone exchange apparatus EX2 transmits a registration request including terminal identification, an IP address and a MAC address to the IP telephone exchange apparatus EX1 ((4) of FIG. 6).

When receiving the registration request from the IP telephone exchange apparatus EX2 (Block ST7a), the controller 12 of the IP telephone exchange apparatus EX1 determines whether or not the host name information is added in the registration request (Block ST7b).

Here, if the host name information is not added to the registration request (No), the controller 12 acquires the MAC address added to the registration request (Block ST7c). The controller 12 refers to the management table 131 (Block ST7d), and determine whether or not the corresponding-Mac address exists in the registration request (Block ST7e).

In this example, since the IP telephone exchange apparatus EX2 performs first registration, the controller 12 reads the unused host name “Exchange 1” from the registration table 132 (block ST7f), registers the host name information “Exchange 1” in the management table 131 by associating it with the apparatus name, the IP address, and the MAC address ((5) of FIG. 6, Block ST7g), and reports a registration response including the registered host name information to the IP telephone exchange apparatus EX2 ((6) of FIG. 6, Block ST7h).

After this, the IP telephone exchange apparatus EX2 which has received the registration response records the reported host name as its own host name ((7) of FIG. 6).

For a method for giving host names, there are a method for giving host names as “Exchange 1”, “Exchange 2” for each apparatus if the apparatuses are IP telephone exchange apparatuses, as “Endpoint 1”, “Endpoint 2” if the apparatuses are end points, and as “IP-Terminal 1”, “IP-terminal 2” if the apparatuses are IP telephone sets so as to be unique in the system, and a method for serially giving host names as “Device 1”, “Device 2” in a connection order with no distinction of methods for giving the host names and of apparatuses so as to be unique in the system.

In Block ST7e, if the corresponding-MAC address exists in the management table 131 (Yes), the controller 12 reads the host name information corresponding to the MAC address from the management table 131 (Block ST7i), and shifts the state to the processing in Block ST7h. Further, in Block ST7b, if the host name information is added in the registration request transmitted from the IP telephone exchange apparatus EX2, the controller 12 ends the processing as it is.

Although regarding the IP telephone exchange apparatus EX3, the IP telephone terminals T1-Tn, the maintenance terminal PC1 and the end points EP1,EP2, the registration is performed in the same flow described for the IP telephone exchange apparatus EX2, when registering to the IP telephone exchange apparatus EX2 of which the end points EP1, EP2 are not the same as those of the maintenance IP telephone exchange apparatus EX1, if the IP telephone exchange apparatus EX2 does not have the information of its own endpoint, the IP telephone exchange apparatus EX2 reports the fact to the maintenance IP telephone exchange apparatus EX1 to register the end points according to the report.

As given above, in the first embodiment, for instance, when IP telephone exchange apparatus EX1 receives the registration request to the management table 131 from the IP telephone exchange apparatus EX2 of which the host name information has not registered yet, the IP telephone exchange apparatus EX1 automatically generates the host name information of the IP telephone exchange apparatus EX2 by reading the unused host name information in the registration table 132 with a plurality of host names pre-registered, and registers the host name information in the management table 131 by associating it with the apparatus name of the IP telephone exchange apparatus EX2, the MAC address and the IP address.

Accordingly, the manual registration in the DHCP/DNS server SV is minimized, and thereby, the system is easily constructed.

In the first embodiment, since the host name information and the MAC address are associated with each other to be registered in the management table 131, the IP telephone exchange apparatus EX1 can determine whether or not the identical MAC address has been registered in the management table 131 for each reception of the registration requests. If the identical Mac address does not exist, the IP telephone exchange apparatus EX1 reads the information of the unused host name from the registration table 132 of the host names. Conventionally, if the identical MAC address exists therein, the telephone exchange apparatus EX1 can supply the appropriate host name information for each apparatus issuing a registration request so as to use the host name information corresponding to the concerned MAC address in the management table 131.

Further, in the first embodiment, the IP telephone exchange apparatus EX2 can recognize the host name information registered by the registration response from the IP telephone exchange apparatus EX1, and can use the recorded host name information at the next registration by recording the host name information.

### Second Embodiment

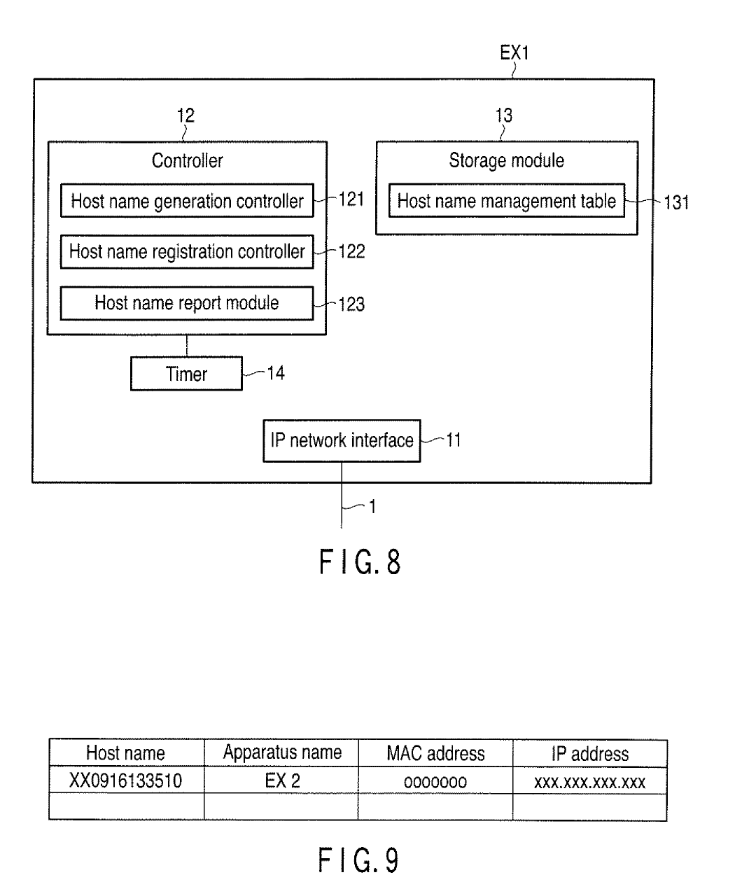

FIG. 8 shows a block diagram depicting a functional configuration of the IP telephone exchange apparatus EX1 as a second embodiment of the invention. In FIG. 8 the same components as those of FIG. 2 are designated by the identical symbols and their explanations will be omitted.

That is, for example, the generation controller 121 refers to the management table 131 based on the MAC address included in the registration request, when a registration request to the management table 131 for the IP telephone exchange apparatus EX2, if any host name is not included in the registration request. And if the same MAC address does not exist in the management table 131, the generation controller 121 generates host name information according to time and date information to be clocked by using a timer 14.

The registration controller 122, as shown in FIG. 9, associates the host name information generated by the generation controller 121 with the apparatus name of the IP telephone exchange apparatus EX2, the MAC address and the IP address to register the host name information in the management table 131. Here, if the time and data clocked by using the timer 14 in reception of the registration request is “ten seconds and thirty five minutes after thirteen o'clock, September 16, 20XX”, the generation controller 121 generates “XX0916133510” as host name information.

As mentioned above, in the second embodiment, since the IP telephone exchange apparatus EX1 automatically generates the host name information by the use of the time and date information clocked by using the timer 14, the exchange apparatus EX1 can automatically generate the host name information in a simple procedure without overlapping with other host names.

### Other Embodiment

The invention is not limited to each of the embodiments given above. For instance, an apparatus production number, etc., may be used for determination of a condition of automatic generation of a host name.

Other than this, the system configuration, the functional configuration of the maintenance IP telephone exchange apparatus, the kind of the condition of the host name, the registration control procedure and content of host name information, etc., may be embodied in various forms without departing from the spirit or scope of the general inventive concept of the invention. A form without using the DHCP server can be used.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone exchange apparatus which connects a plurality of communication apparatuses via an Internet Protocol network, includes a management table with host name information corresponding to each of the plurality of communication apparatuses registered, and makes the plurality of communication apparatuses execute predetermined communication processing based on the management table, comprising:
a generator configured to automatically generate the host name information in accordance with a predetermined condition, when a registration request about an arbitrary communication apparatus to the management table is issued; and
a controller configured to register the host name information generated by the generator in the management table by associating the host name information with the corresponding-communication apparatus.

2. The telephone exchange apparatus of claim 1, wherein the controller registers a media access control (MAC) address in the management table by associating the host name information generated by the generator and a MAC address obtained in reception of the registration request with the corresponding-communication apparatus, when the MAC address specifying the arbitrary communication apparatus is added to the registration request.

3. The telephone exchange apparatus of claim 2, wherein the generator comprising;
a first module configured to determine whether or not the same MAC address as the MAC address added to the registration request is registered in the management table, when the registration request is issued;
a second module configured to automatically generate the host name information in accordance with the predetermined condition, when the MAC address added to the registration request does not exist in the management table, and uses host name information corresponding to the concerned MAC address in the management table, when the MAC address added to the registration request exists in the management table.

4. The telephone exchange apparatus of claim 1, further comprising:
a report module configured to report the host name information generated by the generator to the arbitrary communication apparatus.

5. The telephone exchange apparatus of claim 1, wherein the generator uses at least one of items of unused host name information in a host name registration table with time and date, and a plurality of items of host name information are pre-stored for determining the condition.

6. A host name information assigning method for use in a telephone exchange apparatus which connects a plurality of communication apparatuses via an Internet Protocol network, includes a management table with host name information corresponding to each of the plurality of communication apparatuses registered, and makes the plurality of communication apparatuses execute predetermined communication processing based on the management table, comprising:
automatically generating in accordance with a predetermined condition, when a registration request about an arbitrary communication apparatus to the management table is issued; and
registering the generated host name information in the management table by associating the host name information with the corresponding-communication apparatus.
